(19) United States
(12) Patent Application Publication
(10) Pub. No.: US 2016/0210550 A1
(43) Pub. Date: Jul. 21, 2016

(54) CLOUD-BASED NEURAL NETWORKS

(71) Applicant: Nomizo, Inc., Santa Cruz, CA (US)

(72) Inventors: Theodore MERRILL, Santa Cruz, CA (US); Sumit SANYAL, Santa Cruz, CA (US); Laurence H. COOKE, Los Gatos, CA (US); Tijmen TIELEMAN, Bilthoven (NL); Anil HEBBAR, Bangalore (IN); Donald S. SANDERS, Los Altos, CA (US)

(21) Appl. No.: 14/713,529

(22) Filed: May 15, 2015

Related U.S. Application Data
(60) Provisional application No. 62/105,271, filed on Jan. 20, 2015.

(51) Int. Cl. G06N 3/04

(52) U.S. Cl. CPC G06N 3/04

(57) ABSTRACT

A multi-processor system for data processing may utilize a plurality of different types of neural network processors to perform, e.g., learning and pattern recognition. The system may also include a scheduler, which may select from the available units for executing the neural network computations, which units may include standard multi-processors, graphic processor units (GPUs), virtual machines, or neural network processing architectures with fixed or reconfigurable interconnects.

### CROSS-REFERENCE TO RELATED APPLICATION

This application is a non-provisional patent application claiming priority to U.S. Provisional Patent Application No. 62/105,271, filed on Jan. 20, 2015, and incorporated by reference herein.

### FIELD

Embodiments of the present invention may pertain to various forms of neural networks from custom hardware architectures to multi-processor software implementations, and from tuned hierarchical pattern to perturbed simulated annealing training algorithms, which may be integrated in a cloud-based system.

### BACKGROUND

Due to recent optimizations, neural networks may be favored as the solution for adaptive learning based recognition systems. They may be used in many applications including intelligent web browsers, drug searching, voice recognition and face recognition.

While general neural networks may consist of a plurality of nodes, where each node may process a plurality of input values and produce an output according to some function of its input values, where the functions may be non-linear and the input values may be any combination of both primary inputs and outputs from other nodes, many current applications may use linear neural networks, as shown in FIG. 1. Deep or convolution neural networks may have a plurality of input values 10, which may be fed into a plurality of input nodes 11, where each input value of each input node may be multiplied by a unique weight 14. A function of the normalized sum of these weighted inputs may be outputted from the input nodes 11 and fed to one or more layers of “hidden” nodes 12, which subsequently may feed a plurality of output nodes 13, whose output values 15 may indicate a result of, for example, some pattern recognition. Typically, all the input values 10 may be fed into all the input nodes 11, but many of the connections from the input nodes 11 and between the hidden nodes 12 and their associated weights 14 may be eliminated after training, as suggested by Starzyk in U.S. Pat. No. 7,293,002, granted Nov. 6, 2007.

There have been a variety of neural network implementations in the past, including using arithmetic-logic units (ALUs) in multiple field programmable gate arrays (FPGAs), as described, e.g., by Cloutier in U.S. Pat. No. 5,892,962, granted Apr. 6, 1999, and Xu et al. in U.S. Pat. No. 8,131,659, granted Mar. 6, 2012, or using multiple networked processors, as described, e.g., by Passera et al. in U.S. Pat. No. 6,415,286, granted Jul. 2, 2002, using custom-designed wide memories and interconnects as described, e.g., by Watanabe et al. in U.S. Pat. No. 7,043,466, granted May 9, 2006, and Arthur et al. in US Published Patent Application 2014/0114893, published Apr. 24, 2014, or using a Graphic Processing Unit (GPU), as described, e.g., by Puri in U.S. Pat. No. 7,747,070, granted Jun. 29, 2010. But in each case, the implementation is tuned for a specific purpose, and yet there are many different configurations of neural networks, which may suggest a need for a more heterogeneous combination of processors, graphic processing units (GPUs) and/or specialized hardware to selectively process any specific neural network in the most efficient manner.

### SUMMARY OF THE DISCLOSURE

Various aspects of the present disclosure may include merging, splitting and/or ordering the node computation to minimize the amount of unused available computation across a cloud-based neural network, which may be composed of a heterogeneous combination of processors, GPUs and/or specialized hardware, which may include FPGAs and/or application-specific integrated circuits (ASICs), each of which may contain a large number processing units, with fixed or dynamically reconfigurable interconnects.

In one example, the architecture may allow for leveling and load balancing to achieve near-optimal throughput across heterogeneous processing units with widely varying individual throughput capabilities, while minimizing the cost of processing including power usage.

In another example, methods may be employed for merging and/or splitting node computation to maximize the use of the available computation resources across the platform.

In yet another example, inner product units (IPUs) within a Neural Network Processor (NNP) may perform successive fixed-point multiply and add operations and may serially output a normalized aligned result after all input values have been processed, and may simultaneously place one or more words on both an input bus and an output bus. Alternatively, the IPUs may perform floating-point multiply and add operations and may serially output normalized aligned either floating- or fixed-point results.

In another example, at any given layer of the neural network, multiple IPUs may process a single node, or multiple nodes may be processed by a single IPU. Furthermore, multiple copies of an NNP may be configured to each compute one layer of a neural network, and each copy may be organized to perform its computations in the same amount of time, such that multiple executions of the neural network may be pipelined across the NNP copies.

It is contemplated that the techniques described in this disclosure may be applied to and/or may employ a wide variety of neural networks in addition to deep or convolutional neural networks.

### BRIEF DESCRIPTION OF THE DRAWINGS

Various aspects of the disclosure will now be described in connection with the attached drawings, in which:

FIG. 1 is an example of a diagram of a multi-layer linear neural network,

FIG. 2 is a diagram of a simple neural network processor (NNP), according to an example of the present disclosure,

FIG. 3 is a table depicting an example of the operation of the simple NNP shown in FIG. 2,

FIG. 4 is a diagram of an example of a multi-word output buffer shown in FIG. 2,

FIG. 5 is a diagram of an example of one inner product unit (IPU) shown in FIG. 2,

FIG. 6 is a diagram of an example of a multi-word input buffer shown in FIG. 5,

FIGS. 7 and 8 are diagrams depicting examples of the operation of a multi-word NNP,

FIG. 9 is a diagram of an example of an NNP with configurable interconnect,

FIG. 10 is a diagram of an example of an interconnect element shown in FIG. 9,

FIG. 11 is a diagram of an example of a hierarchy of neural network systems,

FIG. 12 is a diagram of an example of a simple NNP partitioned across multiple chips,

FIG. 13 is a diagram of an example of a queue memory,

FIG. 14 is a diagram of an example of queue translation logic,

FIG. 15 is a high-level diagram of an example of a heterogeneous cloud-based neural network, and

FIG. 16 is a diagram of an example of an interpolator.

### DETAILED DESCRIPTION

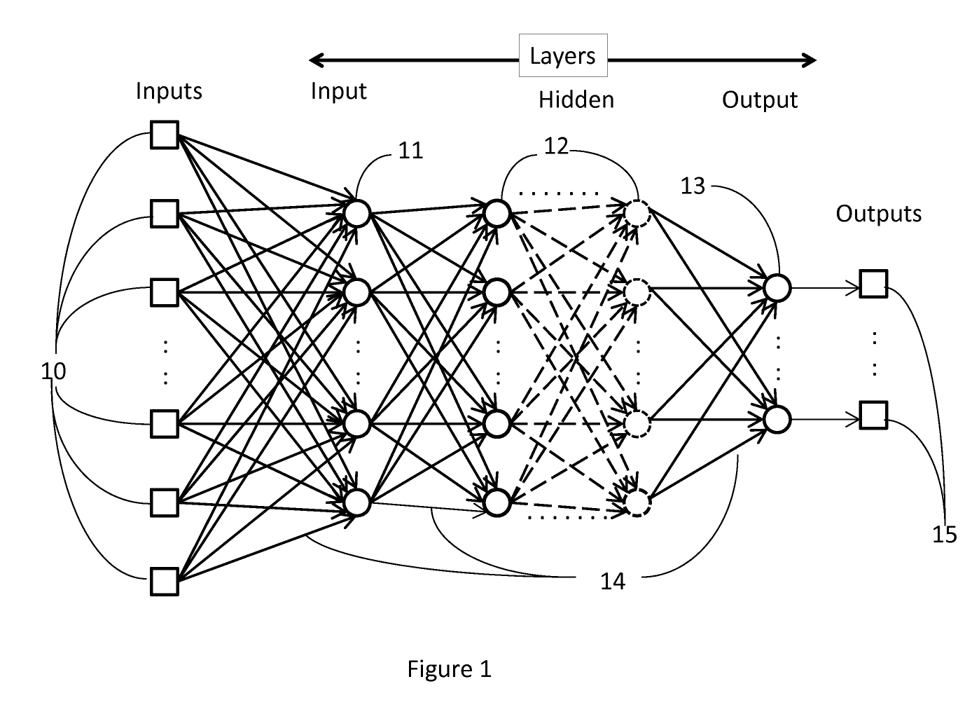

Various aspects of the present disclosure are now described with reference to FIGS. 1-16, it being appreciated that the figures illustrate various aspects of the subject matter and may not be to scale or to measure.

### Modules

In one example, at least one module may include a plurality of FPGAs that may each contain a large number of processing units for merging and splitting node computation to maximize the use of the available computation resources across the platform.

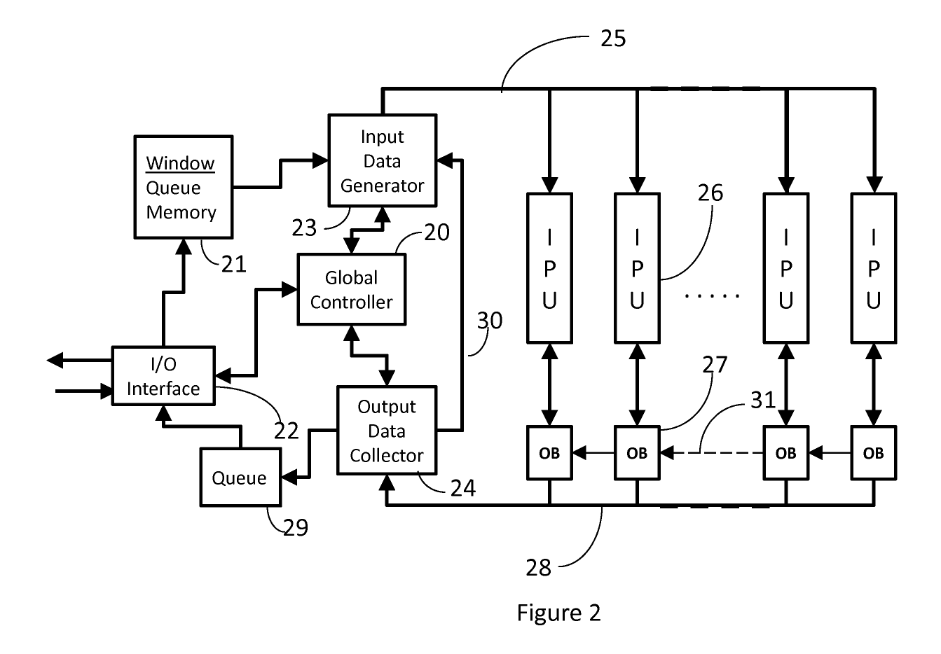

Reference is now made to FIG. 2, a diagram of a simple neural network processor (NNP) architecture, which may comprise a plurality of inner product units (IPUs) 26, each of which may be driven in parallel by an input bus 25 that may be loaded from an Input Data Generator 23. The window/queue memory 21 may consist of a plurality of sequentially written, random-address read blocks of memory. An input/output (I/O) interface 22, which may be a PCIe, Firewire, Infiniband or other high-speed bus, or which may be any other suitable I/O interface, may sequentially load one of the blocks of memory 21 with input data. Simultaneously, the Input Data Generator 23 may read one or more overlapping windows of data from one or more of the other already sequentially loaded blocks of memory 21 for distribution to the IPUs 26. Each IPU 26 may drive an output buffer 27, which may sequentially output data to an Output Data Collector 24, through an output bus 28. The selection of which output buffer to enable may be performed by the Global Controller 20 or by shifting an output bus grant signal 31 successively from one output buffer 27 to a next output buffer 27. The Output Data Collector 24 may then load the Input Data Generator 23 directly 30 for subsequent layers of processing. After the neural network has concluded at least some processing, which may be for a single layer or all the layers, the output data may be removed from the Output Data Collector 24 through an output Queue 29 to the I/O interface 21. The I/O interface 21 may have a plurality of unidirectional external interfaces. Alternatively, the Output Data Collector 24 may also write out data, while writing intermediate output data back 30 into the Input Data Generator 23. A global controller 20 may, either by instructions or through a configurable finite state machine, control the transfer of data through the I/O interface 22 and the IPUs 26.

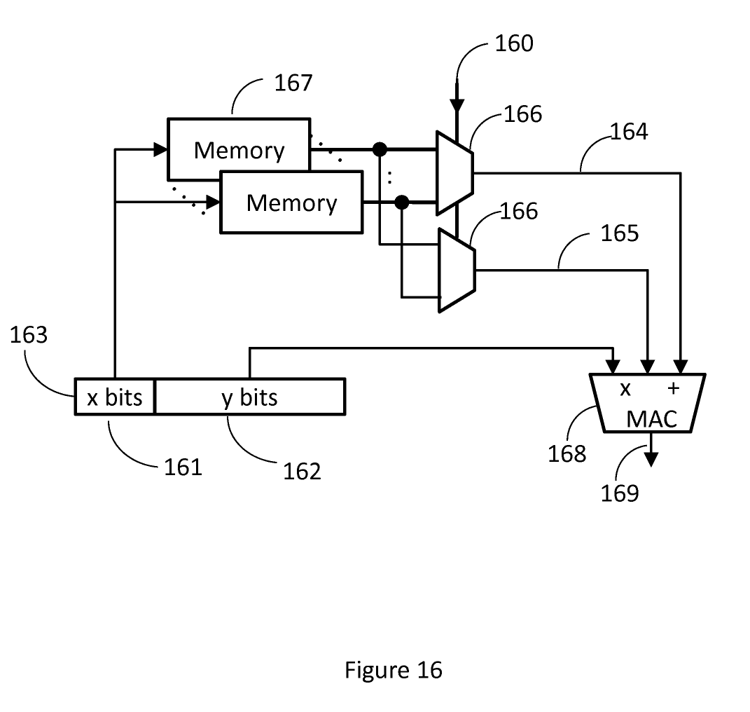

Reference is now made to FIG. 16, a diagram of an interpolator, which may be connected to the input of the output bus 28 within the Output Data Collector 24 in FIG. 2. In one implementation, this interpolator may perform the function of Interpolate=f₁(x)+y*f₂(x), where x 161 and y 162 are selected portions of an input 163 and f₁(x) 164 and f₂(x) 165 are data stored in locations having address x from two memories 166 selected from among a plurality of memories 167, as determined by control inputs 160. A multiply-accumulate 168 may be performed on the resulting values, producing the output 169.

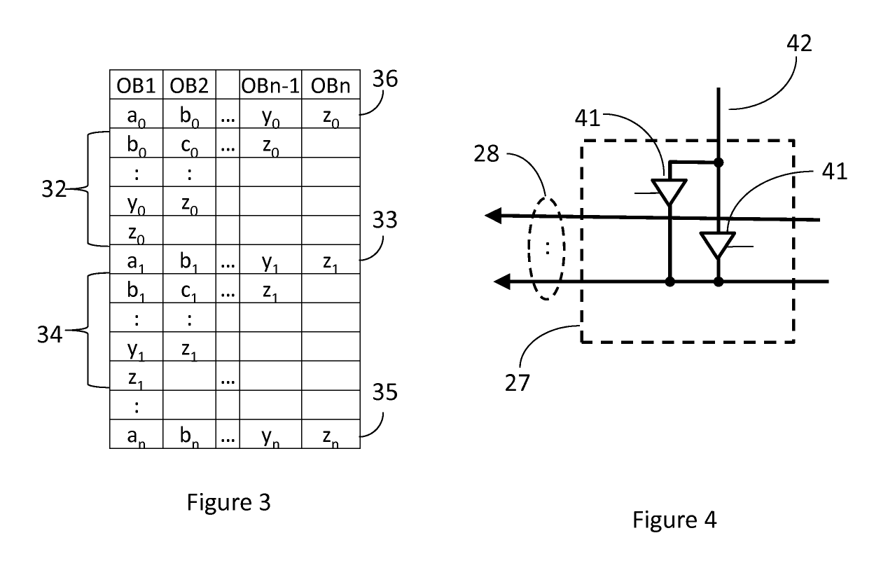

In one example of the simple NNP architecture, the IPUs 26 may perform only sums and output an average, or only compares and output a maximum or a minimum, and in another example, each IPU 26 may perform a fixed-point multiply and/or add operation (multiply-accumulate (MAC)) in one or more clock cycles, and may output a sum of products result after a plurality of input values have been processed. In yet another example, the IPU 26 may perform other computationally-intensive fixed-point or floating-point operations, such as, but not limited to, Fast Fourier Transforms (FFTs), and/or may be composed of processors with reconfigurable instruction sets. Given a neural network as in FIG. 1, with m input values 10 feeding k input nodes, the IPUs 26 in FIG. 2 may output their results (a₀-z₀) into their respective output buffers 27 after m clock cycles, as depicted in FIG. 3 in row 36. Then, for the next k−1 clock cycles, the output results for those k input nodes may be outputted 32, and on each cycle, the output results may be simultaneously inputted back into the IPUs 26 as input values for the next layer of nodes, whereby, on the m+k+1^{st} clock, the next layer of results (a₁-z₁) may be available in the output buffers, as shown in row 33, and these results may be output and re-input 34 to the IPUs 26. This process may repeat until the output values 15 in FIG. 1 are loaded into the output buffers, as shown in row 35 in FIG. 3, and may be outputted in the same manner as described in conjunction with previous layers 32 and 34.

In another example, the NNP architecture may simultaneously write multiple words on input bus 25 and output multiple words on the output bus 28 in a single clock cycle.

Reference is now made to FIG. 4, a diagram of an example of a multi-word output buffer 27 driving a multi-word output bus 28, as shown in FIG. 2. In this case, the output 42 of each IPU 26 may be placed on any one of a plurality of words on the output bus 28 by one of a plurality of switches 41, where the rest of the switches 41 select the word from a previous section of the bus 28. In this manner, two or more output values from two or more IPUs 26 may be shifted on a given clock cycle to the Output Data Collector 24 as shown in FIG. 2.

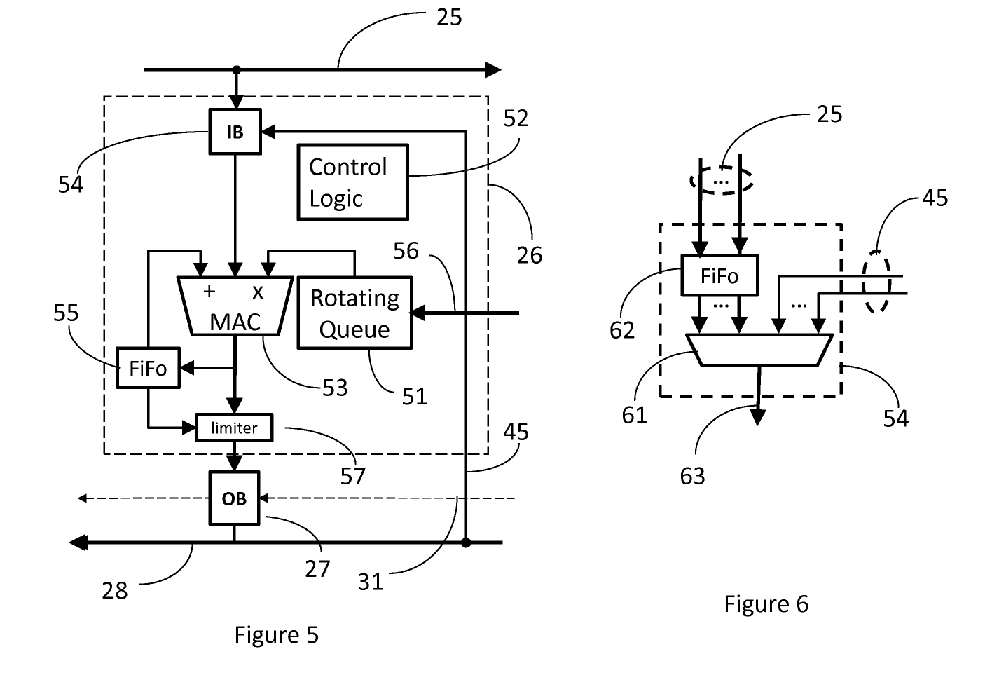

Reference is now made to FIG. 5, a diagram of an example of one inner product unit (IPU) 26, as shown in FIG. 2. The IPU 26 may perform, within a MAC 53, optionally, a multiply of input data with data from a rotating queue 51, and optionally, an addition with data from prior results of the MAC 53. The prior results from the MAC 53 may be optionally temporarily stored in a First-in First-out queue (FiFo) 55. The IPU 26 may be pipelined to perform these operations on every clock cycle, or may perform the operations serially over multiple clock cycles. Optionally, the IPU 26 may also simultaneously capture data from the input bus 25 or the output bus 28 in the input buffer 54, and may deposit results from the FiFo 55 into the output buffer 27. Each IPU's rotating queue 51 may be designed to exactly contain its neural network weight values, which may be preloaded into the rotating queue 51. Furthermore, the queue's words may be selected by a rotating a select bit around a circular shift register. Local control logic 52 may, either by instructions or through a configurable finite state machine, control the transfer of data from the input bus 25 or another IPU's output 45 through the input buffer 54 into the MAC 53, and/or may select data in the FiFo 55 to send to either the MAC 53 or to the output buffer 27 through a limiter 57, which may rectify the outputted result and/or limit it, e.g., through some purely combinatorial form of saturation, such as masking.

Reference is now made to FIG. 6, a diagram of an example of a multi-word input buffer 54, as shown in FIG. 5. Each word on the input bus 25 may be loaded into an input buffer or FiFo 62, and the resulting output 63 may be selected 61 from one or more words of the FiFo 62, and one or more words from another IPU's output 45.

Reference is again made to FIG. 5. Depending on the implementation of the NNP, either single or multiple words may be transferred through the input buffers 54 and/or the output buffers 27 of each IPU 26. Furthermore, in the multi-word implementation, the local control logic 52 may also control the selection of the output from the input buffer 54 and to the output bus 28 from the output buffer 27.

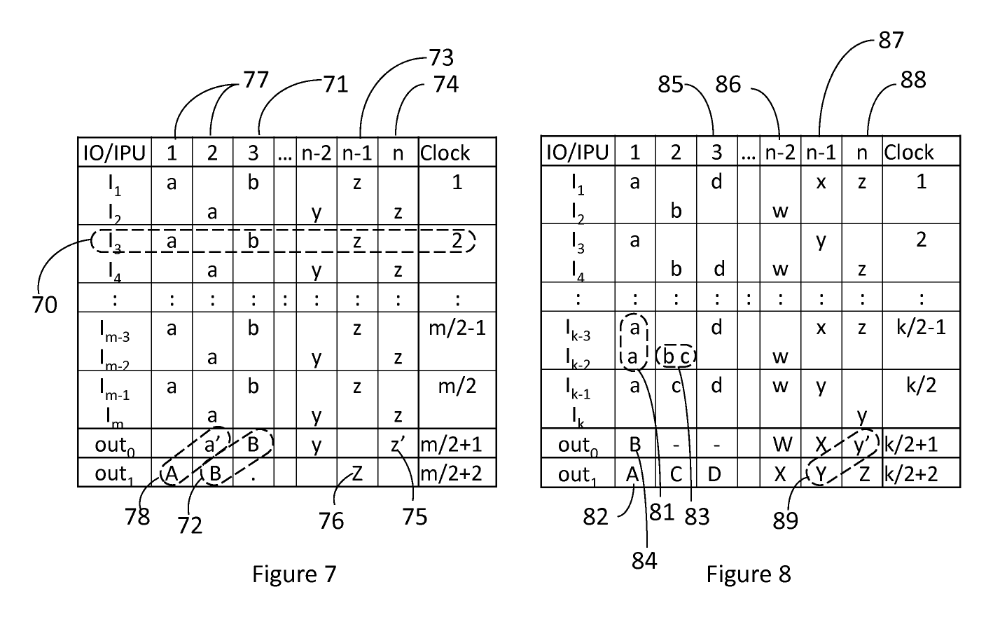

In another arrangement, at any given layer of the neural network, multiple IPUs 26 may process a single node, or multiple nodes may be processed by a single IPU 26. Reference is now made to FIG. 7, a diagram depicting an example of the operation of a multi-word NNP. The first column shows the input values (I₁ through Iₙ) and two output cycles (out₀ and out₁). The last column shows the clock cycle of the operation. The middle columns show the nodes a through z, which may be processed by IPUs 1 through n, where n>z, in an NNP architecture that may have a two-word input bus 25 and a single-word output bus 28 from the output buffers 27. For example, in row 70, the first word of the input bus 25 may be loaded with I₃, which may be used by IPUs 1, 3 and n−1 to compute nodes a, b and z, respectively. Now, in this configuration, node b may only be calculated by IPU 3, as shown in column 71, because node b may only have connections to the odd inputs (I₁, I₃, etc.) The result B 72 (where, in this discussion, a capital letter corresponds to the respective output of the node denoted by the same lower-case letter; e.g., “B” refers to the output of node b) may be available on the first output cycle and may be shifted to IPU 2 on the next cycle. Node z may require all inputs and may, therefore, be split between IPUs n−1 and n, as shown in columns 73 and 74. As a result, column 74 may produce an intermediate result z′ 75, which may be loaded into IPU n−1 and added to the computation performed by IPU n−1 to produce Z 76 on the next cycle. Similarly, node a may also require all inputs, and thus may be processed by IPUs 1 and 2 in columns 77, producing an intermediate result a′ on the first output cycle and the complete result A on the next output cycle 78, while B 72 is being loaded into the output buffer for IPU 2. In this manner, the computation for a node may be split between or among multiple IPUs.

Reference is now made to FIG. 8, another diagram depicting a further example of the operation of the same multi-word NNP, which may be processing a different number nodes z, where z<n. In some cases, it may not be possible to sort the inputs such that only one input is used within each IPU on each clock cycle. For example, two inputs 81, both of which are available on the same clock cycle, may be required to process node a. By storing Iₖ₋₂ in the input buffer's FiFo 62 in FIG. 6, A 82, the result of processing node a, may be available on the second output cycle. Similarly, two or more nodes may be processed by the same IPU, and two or more nodes may require the same input 83. In this case, the input value may be both used for node b and saved to process on the next cycle for node c, which may allow the processing of node b to be completed and outputted one cycle early, such that the result may be available on the output buffer of IPU 1 on the first output cycle 84. On the other hand, node c may require an extra cycle so that C may be outputted on the next output cycle, which may require D in column 85 to also be output on the same cycle. Similarly, z may be delayed in column 88 to allow scheduling of Y 89, and W in column 86 may be outputted on the first output cycle to allow scheduling of X. It should be noted that the FiFo 55 in FIG. 5 may be used to store intermediate results when multiple nodes are being processed in an interleaved manner as in column 87.

It is further contemplated that an ordering of the computations may be performed to minimize the number clock cycles necessary to perform the entire network calculation as follows:
a. Assign an arbitrary order to the network outputs;
b. For each layer of nodes from the output layer to the input layer:
   a) split and/or merge the node calculations to evenly distribute the computation among available IPUs,
   b) Assign the node calculations to IPUs based on the output ordering, and
   c) Order the input values to minimize the computation IPU cycles;
c. Repeat steps a and b until a minimum number of computation cycles is reached.
For a K-word input, K-word output NNP architecture, a minimum number of computation cycles may correspond to the sum of the minimum computation cycles for each layer. Each layer's minimum computation cycles is the maximum of: (a) one plus the ceiling of the sum of the number of weights for that layer divided by the number of available IPUs; and (b) the number of nodes at the previous layer divided by K.

For example, if there are 100 nodes at one layer and 20 nodes at the next layer, where each of the 20 nodes has 10 inputs (for a total of 200 weights), and there are 50 IPUs to perform the calculations, then after splitting up the node computations, there would be 4 computations per IPU plus one cycle to accumulate results (other than the cycles to input the results to the next layer), for a total of 5 cycles. Unfortunately, there are 100 outputs from the previous layer, so the minimum number of cycles would have to be 100/K. Clearly, if K is less than 20, loading the inputs becomes the limiting factor.

As such, in some implementations, the width of the input bus and output bus may be scaled based on the neural network being processed.

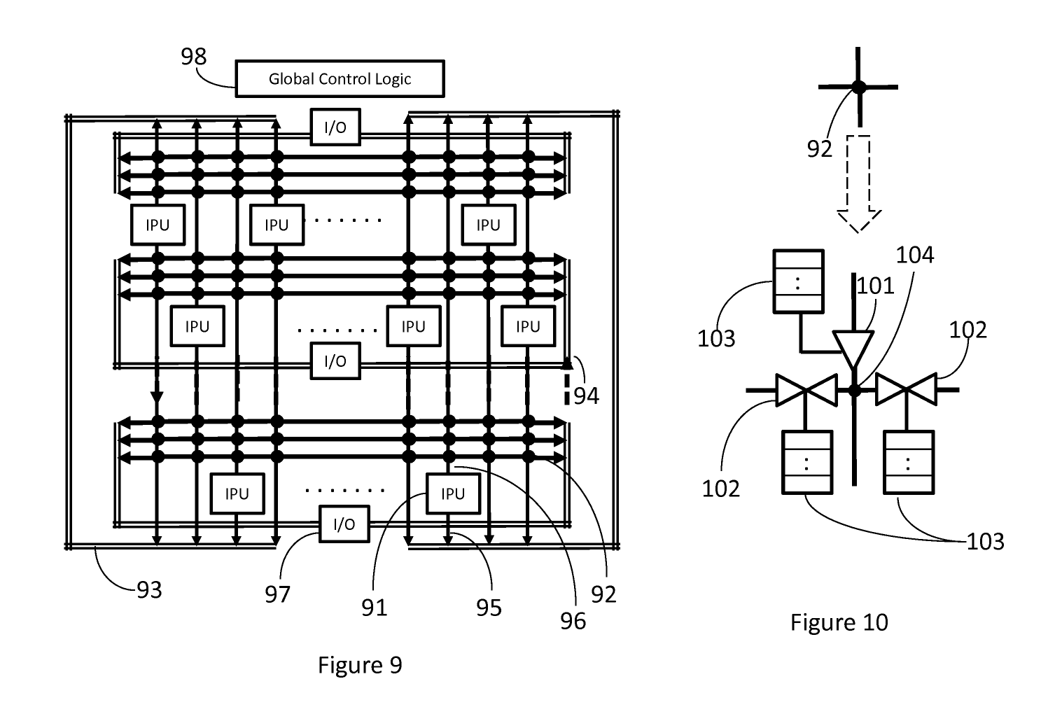

According to another variation, at least one platform may include a plurality of IPUs connected with a reconfigurable fabric, which may be an instantly reconfigurable fabric. Reference is now made to FIG. 9, a diagram of an example of an NNP with configurable interconnect. A fabric may be composed of wire segments in a first direction with end segments 94 connected to I/O 97 and of wire segments in a second direction with end segments connected 93. The fabric may further include programmable intersections 92 between the first and second direction wire segments. The wire segments may be spaced between an array of IPUs 91, where each IPU 91 may include either a floating-point or fixed-point MAC and, optionally, a FiFo buffer on its input 96 and/or a FiFo buffer on its output 95. Reference is now made to FIG. 10, a diagram of an example of an interconnect element 92, as shown in FIG. 9. Each interconnect element may have a tristate driver 101 driving the intersection 104 with one transmission gate 102 on either side of the intersection 104, with a rotating FiFo 103 controlling each of the tristate driver 101 and the transmission gates 102, such that the configuration between FiFo 103 outputs and inputs may be reconfigured as often as every clock cycle. In this manner, the inputs may be loaded into the appropriate IPUs, after which the fabric may be reconfigured to connect each IPU output to its next-layer IPU inputs. The depth of the rotating FiFos 103 may be limited by using row and column clocking logic controlled by the Global Controller 20 (see FIG. 2) to selectively reconfigure the fabric in one or more regions in a respective clock cycle.

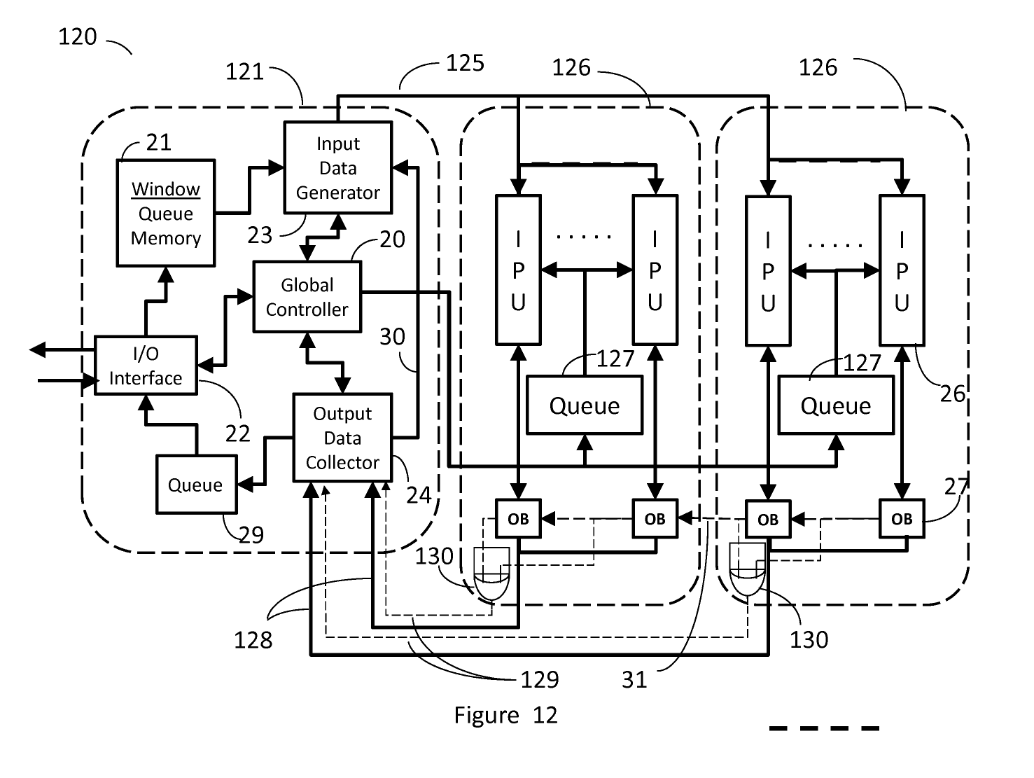

In other implementations, a Neural Network Processor may be distributed across multiple FPGAs or ASICs, or multiple Neural Network Processors may reside within one FPGA or ASIC. The NNPs may utilize a multi-level buffer memory to load the IPUs 26 with instructions and/or weight data. Reference is now made to FIG. 12, a diagram of another example of a fixed Neural Network Processor architecture 120 partitioned across multiple chips. One or more copies of the logic 121 consisting of the Global Controller 20, Input Data Generator 23, Output Data Collector 24, the Window Queue memory 21, the output Queue 29 and the I/O Interface 22 may reside in one chip, optionally with some of the IPUs 26, while the rest of the IPUs 26 and output buffers 27 may reside on one or more separate chips. To minimize delay and I/O, the input bus 125 may be distributed to each of the FPGAs and/or ASICs 126 to be internally distributed to the individual IPUs. Similarly, each of the chips 126 may have an output bus 128 separately connected to the Output Data Collector 24. In this case, the last grant signal 31 from one chip 126 may connect from one chip to the next, and a logical OR 130 of all of each chip's internal grant signals may be connected 129, along with each chip's output bus 128, to the Output Data Collector 24, such that the Output Data Collector 24 may use the chip's grant signal 129 to enable the currently active output bus. It is further contemplated that such splitting of the input and output buses may occur within a chip as well as between chips.

In one example implementation, multiple copies of the NNP may be configured to each compute one respective layer of a neural network, and each copy may be organized to perform its computations in the same amount of time as the other copies, such that multiple executions of the neural network may be pipelined level-by-level across the copies of the NNP. In another implementation, the NNPs may be configured to use as little power as possible to perform the computations for each layer, and in this case, each NNP may compute its computations in a different amount of time. To synchronize the NNPs, an external enable/stall signal from a respective receiving NNP may be sent from the receiving NNP's I/O interface 22 back through a corresponding sending NNP's I/O interface 22, to signal the sending NNP's Global Controller 20 to successively enable/stall the sending NNP's output queue 29, Output Data Collector 24, Input Data Generator 23, Window/Queue memory 21, and issue a corresponding enable/stall signal to the sending NNP from which it is, in turn, receiving data.

In yet a further example implementation, the Global Controller 20 may control the transfer of neural network weights from the I/O Interface 22 to one or more Queues 127 in each of one or more chips containing the IPUs 26. These Queues 127 may, in turn, load each of the IPUs' Rotating Queues 51, as shown in FIG. 5. It is also contemplated that there may be a plurality of levels of queues, according to some aspects of this disclosure, and the IPU Rotating Queue 51 may be shared by two or more IPUs. The Global Controller 20 may manage the weight and/or instruction data across any or all levels of the queues. The IPUs may have unique addresses, and each level of queues may have a corresponding address range. In order to balance the bandwidths of all levels of queues, it may be helpful to have each level, from the IPU level up to the whole Neural Network level, have a word size that is some multiple of the word size of the previous level.

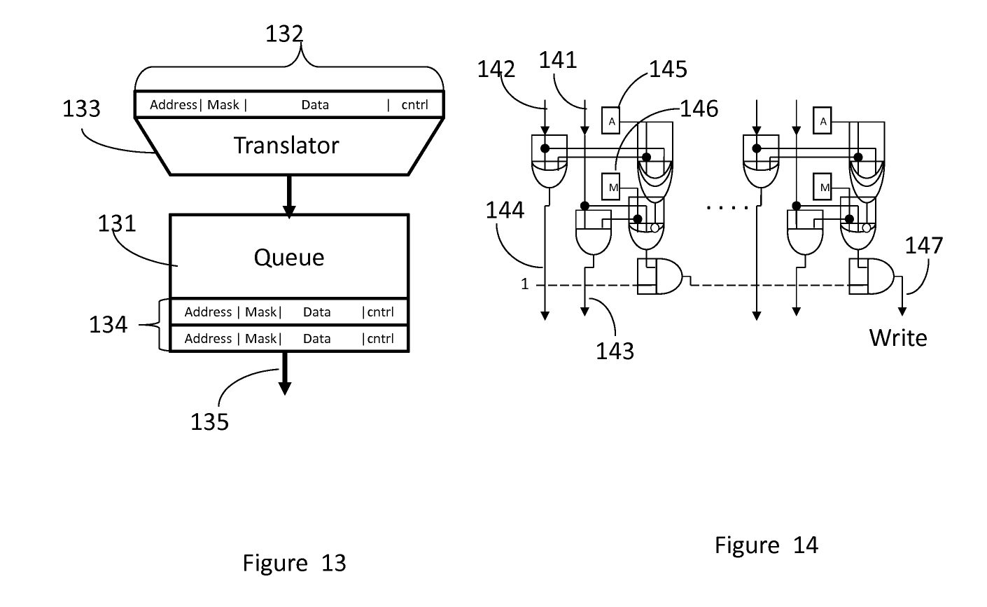

Reference is now made to FIG. 13, a diagram of an example of a queue memory. In order to minimize the copies of identical data within the queues, a line of data 132 may include:
a) the one or more words of data,
b) its IPU address, a ternary mask the size of the IPU address, where one or more “don't care” bits may map the line of data to multiple IPUs, and
c) a set of control bits that define
   a. which data words are valid, and
   b. a repeat count for valid words.

In this manner, only one copy of common data may be required within any level of the queues, regardless of how many IPUs actually need the data, while the individual IPUs with different data may be overwritten. The data may be compressed prior to sending the data lines to the NNP. In order to properly transfer the compressed lines of data throughout the queues, lines of data 132 inputted to a queue 131 may first be adjusted by a translator 133 to the address range of the queue. If the translated address range doesn't match the address range of the queue, the line of data may not be written into the queue. In order to match bandwidths of the levels of queues, each successive queue may output smaller lines of data than it inputs. When splitting the inputted data words into multiple data lines, the translation logic may generate new valid bits and may append a copy of the translated IPU address, mask bits, and the original override bit to each new line of data, as indicated by reference numeral 134.

IPU-Node computation weights may be pre-loaded and/or pre-scheduled and downloaded to the Global Controller 20 with sufficient time for the Global Controller 20 to translate and transfer the lines of data out to their respective IPUs. All data lines may “fall” through the queues, and may only be stalled when the queues are full. Queues may generally only hold a few lines of inputted data and may generally transfer the data as soon as possible after receiving it. No actual addresses may be necessary, because the weights may be processed by each IPU's rotating queue in the order in which they are received from the higher level queues.

Reference is now made to FIG. 14, a diagram of an example of queue translation logic 133. Each bit of the inputted address 142 and mask 141 may be translated into a new address bit 144 and mask bit 143 by the IPU address range of the queue, which may reside in the corresponding address bit 145 and mask bit 146. When the inputted address falls within the queue's address range, the write line 147 may transition to a particular level, e.g., high, in the example of FIG. 14, to signal that the line of data may be written into the queue. It is further contemplated that a repeat count field may be additionally included in each line of data so that the valid words may be repeatedly loaded into an IPU's queue.

In yet another example configuration, a cloud-based neural network may be composed of a heterogeneous combination of processors, GPUs and/or specialized hardware, including, e.g., but not limited to a plurality of FPGAs, each containing a large number processing units, with fixed or dynamically reconfigurable interconnects.

### System

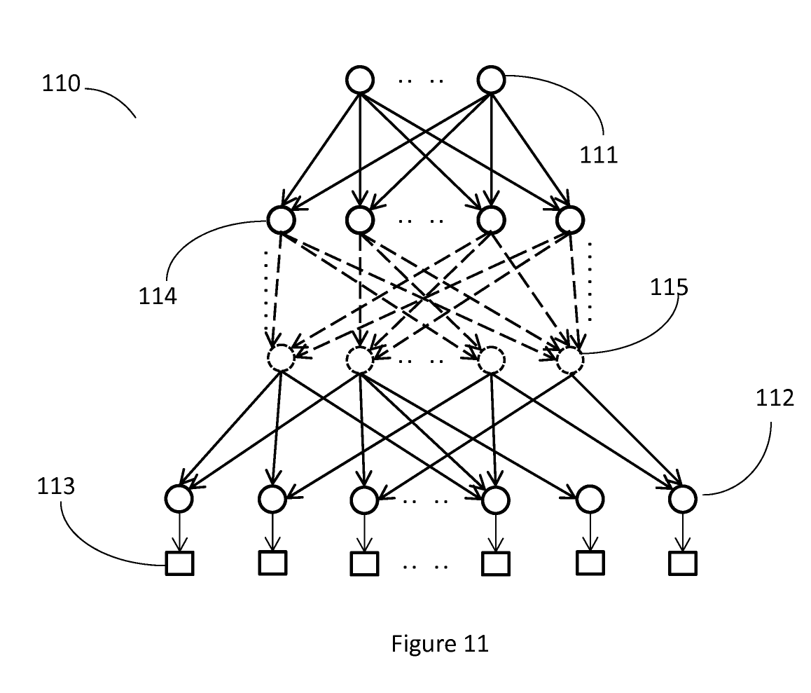

In one example of a system, a network of neural network configurations may be used to successively refine pattern recognition to a desired level, and training of such a network may be performed in a manner similar to training individual neural network configurations. Reference is now made to FIG. 11, a diagram of an example of a hierarchy of neural network systems. An untrained network may consist of primary recognition at the first level 111 with successive refinement as subsequent levels down to specific recognition at the lowest level 112, with corresponding confirming recognitions at the outputs 113. For example, the top level 111 may be recognition of faces, with subsequent levels recognizing features of faces, down to recognition of specific faces at the bottom level 112. Intermediate levels 114 and 115 may recognize traits, such as human or animal, male or female, skin color, hair color, nose or eye types, etc. These neural networks may be manually created or automatically generated from high profile nodes that coalesce out of larger trained neural networks. In this fashion, a hierarchy of smaller, faster neural networks may be used to quickly apply specific recognition to a large, very diverse sample base.

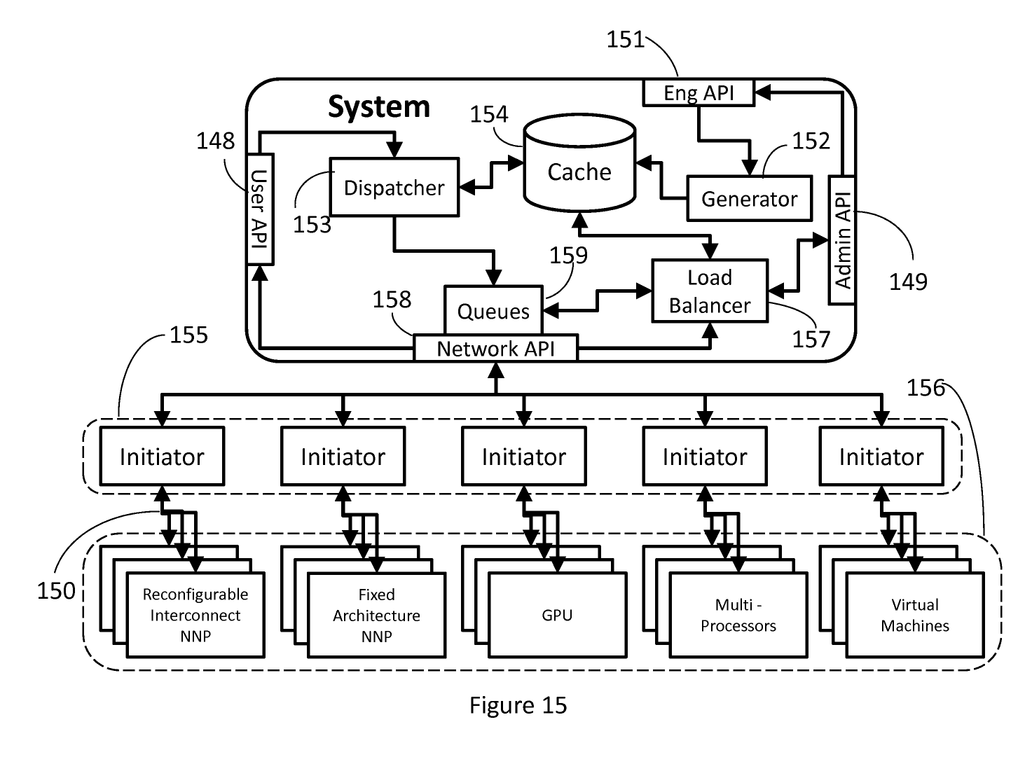

In another example, a cloud-based neural network system may be composed of a heterogeneous combination of processors, GPUs and/or specialized hardware, which may include, but is not limited to, a plurality of FPGAs that may each contain a large number processing units, which may have fixed or dynamically reconfigurable interconnects to execute a plurality of different implementations of one or more neural networks. Reference is now made to FIG. 15, a high level diagram of an example of a heterogeneous cloud-based neural network. The system may contain User 148, Engineering 151 and Administration 149 API interfaces. The Engineering interface 151 may provide engineering input and/or optimizations for new configurations of neural networks, including, but not limited to refined, neural networks due to training or optimizations of existing configurations to improve power, performance or testability. There may be multiple configurations for any given neural network, where each configuration may be associated with a specific type of NNP 156, and may only execute on that type of NNP, and all configurations for any given neural network may produce the same results, to a defined level of precision, for all recognition operations that may be applied to the neural network. The generator 152, through various software and design automation tools, may translate the engineering inputs into specific implementations of neural networks, which may be saved in the Cache 154 for later use. It is further contemplated that one or more of the fixed-architecture NNPs in 156 may be equivalent to 120 in FIG. 12, and may include a plurality of FPGAs, which may be reconfigured for each neural network, or layer of neural network, by the generator 152. The generator 152 may automatically generate a number of different configurations, which may include, but are not limited to, different numbers of IPUs, sizes of input and output buses, sizes of words, sizes of FiFos, sizes of the IPU's rotating queues and their initial contents, any or all of which may be stored in the cache 154 for later use by the Dispatcher 153. It is contemplated that at least some of the configurations may minimize power usage by minimizing transfers of data, addressing of data, or computation of data to only that which is computationally necessary. It is further contemplated that any configuration may be composed of layers that may be executed on more than one type of processor or NNP and that the cache 154 may be a combination of volatile and non-volatile memories and may contain transient and/or permanent data.

The user requests may be, for example, queries with respect to textual, sound and/or visual data, which require some form of pattern recognition. For each user request, the dispatcher 153 may extract the data from the User API 148 and/or the Cache 154, assign the request to an appropriate neural network, and may load the neural network user request and the corresponding input data into a queue for the specific neural network within the queues 159. Thereafter, when an appropriate configuration is available, data associated with each user request may be sent through the Network API 158 to an initiator 155, which may be tightly coupled 150 to one or more of the same or different types of processors 156. In one example, the dispatcher 153 may assign user requests to a specific NNP, being controlled by an initiator 155. In another example, the initiator 155 may assign user requests to one or more of the processors 156 it controls. The types of neural network processors 156 may include, but are not limited to, a reconfigurable interconnect NNP, a fixed-architecture NNP, a GPU, standard multi-processors, and/or virtual machines. Upon completion of the execution of a user request on a one or more processors 156, the results may be sent back to the User API 148 via the associated initiator 155 through the Network API 158.

The Load Balancer 157 may manage the neural network queues 159 for performance, power, thermal stability, and/or wear-leveling of the NNPs, such as leveling the number of power-down cycles or leveling the number of configuration changes. The Load Balancer 157 may also load and/or clear specific configurations on specific initiators 155 or through specific initiators 155 to specific types of NNPs 156. When not in use, the Load Balancer 157 may shut down NNPs 156 and/or initiators 155, either preserving or clearing their current states. The Admin API 149 may include tools to monitor the queues and may control the Load Balancer's 157 priorities for loading or dropping configurations based on the initiator resources 155, the configurations power and/or performance and the neural network queue depths. Requests to the Engineering API 151 for additional configurations may also be generated from the Admin API 149. The Admin API 149 may also have hardware status for all available NNPs, regardless of their types. Upon initial power-up, and periodically thereafter, each initiator 155 may be required to send its current status, which may include the status of all the NNPs 156 it controls, to the Admin API 149 through the load balancer. In this manner, the Admin API 149 may be able to monitor and control the available resources within the system.

In yet another aspect, a respective neural network may have a test case and a multi-word test case checksum. Upon execution of the test case on a configuration of the neural network, the test input data, intermediate outputs from one or more levels of the neural network and the fmal outputs may be exclusive-OR condensed by the initiator 155 associated with the neural network into an output checksum of a size equivalent to that of the test case checksum and compared with the test case checksum. The initiator 155 may then return an error result if the two checksums fail to match. Following loading of each configuration, the Load Balancer 157 may send the initiator 155 the configuration's neural network test case, and periodically, the Dispatcher 153 may also insert the neural network's test case into its queue.

It will be appreciated by persons skilled in the art that the present invention is not limited by what has been particularly shown and described hereinabove. Rather the scope of the present invention includes both combinations and sub-combinations of various features described hereinabove as well as modifications and variations which would occur to persons skilled in the art upon reading the foregoing description and which are not in the prior art.

What is claimed is:

1. A cloud-based neural network system for performing pattern recognition tasks, the system comprising:
a heterogeneous combination of neural network processors, wherein the heterogeneous combination of neural network processors includes at least two neural network processors selected from the group consisting of:
a reconfigurable interconnect neural network processor;
a fixed-architecture neural network processor;
a graphic processor unit;
a multi-processor unit; and
a virtual machine;
wherein each neural network processor includes a plurality of processing units.

2. The system as in claim 1, wherein a respective pattern recognition task is assigned to execute on one of the neural network processors.

3. The system as in claim 2, wherein assignment of pattern recognition tasks is balanced to minimize the cost of processing.

4. The system as in claim 1, further comprising:
a user application programming interface (API);
an engineering API; and
an administration API.

5. The system as in claim 1, wherein a respective pattern recognition task is executed using a neural network comprising multiple layers of nodes.

6. The system as in claim 5, wherein a respective layer of the multiple layers of nodes is executed on a different neural network processor from at least one other respective layer of the multiple layers of nodes.

7. The system as in claim 6, wherein one or more results from a respective neural network processor are pipelined to a successive neural network processor.

8. The system as in claim 7, wherein a respective neural network processor synchronously executes its respective layer of the multiple layers of nodes.

9. The system as in claim 5, wherein a respective neural network processor includes a plurality of inner product units (IPUs); and wherein at least one node is executed on more than one IPU.

10. The system as in claim 5, wherein a respective neural network processor contains a plurality of IPUs; and wherein at least one IPU executes more than one node.

11. A neural network processor, comprising:
a plurality of inner product units (IPUs), wherein a respective IPU performs at least one of:
successive fixed-point multiply and add operations;
successive floating-point multiply and add operations;
successive sum operations; or
successive compare operations;

12. The neural network processor as in claim 11, wherein a respective IPU is configured to output, after all input values to the neural network processor have been processed, a result selected from the group consisting of:
a fixed-point result;
a floating-point result;
an average;
a maximum; and
a minimum.

13. The neural network processor as in claim 11, further comprising:
an input bus; and
an output bus,
wherein at least one word is simultaneously placed each of the input bus and the output bus.

14. A method of testing a neural network using a neural network test case comprising input data, intermediate outputs for respective levels of the neural network, final outputs, and a multi-word checksum, the method comprising:
condensing the input data, intermediate outputs and final outputs into an output checksum; and
comparing the output checksum with the multi-word checksum.

15. The method as in claim 14, wherein the condensing is performed using an exclusive-or function.

16. The method as in claim 14, wherein the output checksum and the multi-word checksum comprise a same number of words, and wherein the comparing comprises comparing a respective output checksum word with a corresponding multi-word checksum word.

17. A hierarchical processing network, comprising:
a plurality of neural network configurations in a hierarchical organization,
wherein the neural network configurations are configured to perform successive levels of pattern recognition, wherein each successive level is a more specific pattern recognition than a previous level.
